(19) United States
(12) Patent Application Publication
(10) Pub. No.: US 2016/0314540 A1
(43) Pub. Date: Oct. 27, 2016

(54) PRICE ASSESSMENT PLATFORM

(71) Applicant: Prima Regulated Markets Limited, London (GB)

(72) Inventors: Kevin McGeeney, Le Mont sur Lausanne (CH); Matthew Stone, London (GB)

(21) Appl. No.: 15/096,679

(22) Filed: Apr. 12, 2016

Related U.S. Application Data
(60) Provisional application No. 62/150,583, filed on Apr. 21, 2015.

(51) Int. Cl. G06Q 40/00; G06Q 40/06; G06Q 40/04

(52) U.S. Cl. CPC G06Q 40/10; G06Q 40/04; G06Q 40/06

(57) ABSTRACT

Methods and systems for producing price assessments are disclosed. In certain implementations, the methods and systems may include establishing an opening price and setting the price assessment to the opening price. An assessment period having a length may be commenced during which pricing input may be received and the price assessment is displayed. The pricing assessment may be updated based on the input. The assessment period length may be modified responsive to determining that a qualifying event has occurred.

### CROSS-REFERENCE TO RELATED APPLICATIONS

This application claims benefit of the earlier filing date of U.S. Provisional Application No. 62/150,583 entitled “PRICE ASSESSMENT PLATFORM”, filed Apr. 21, 2015. The aforementioned provisional application is hereby incorporated by reference in its entirety, for any purpose.

### BACKGROUND

The financial services and commodities industries are heavily dependent on price assessments published as fair value benchmarks by Price Reporting Agencies (PRAs) to facilitate index-linked physical and derivatives trade. These assessments are used in a variety of functions, including price references for physical term delivery contracts, fixings for exchange-listed derivatives contracts, internal mark-to-market of corporate risk positions and internal corporate transfer pricing, and calculation of governmental tax regimes and corporate tax liabilities. Traditional approaches to price assessment by current PRAs may create discord in the market by presenting subjective and opaque analysis, assessing movable product specifications, and/or enabling trading stampedes amongst participants aiming to influence the assessment. Existing assessments are also ill-designed to meet the emerging documentation and analysis standards increasingly required by compliance and regulatory authorities. Current methodologies typically fall into one of three categories, each with their own inherent flaws.

Some PRAs use a journalistic survey of market participants by telephone, instant message and email to establish the market clearing price according to a published methodology during a set time frame. This method gives undue subjective assessment leeway to individual assessors grappling with scattered, incomplete, and often partial arrays of information, not necessarily delivered by named or vetted counterparties.

Some PRAs calculate a volume weighted average of trades, bids, and offers submitted to a published electronic screen during a set time frame. By using a defined cutoff point for price assessments, this method artificially steers or restricts the liquidity that can be considered towards a benchmark. Regulators are presented with a “snapshot” overview of a completed historical session, which will necessarily lack real time context and trade behavior detail. Bids and offers not considered towards the published electronic process will not be captured in the system's historical overview.

Some PRAs establish price assessment based on the last trade or spread between highest bid and lowest offer in accordance with methodology at a specific time of day. This methodology gives undue and artificial influence to time when it serves as the main fundamental driver of price, ignoring the key requirement of an efficient, orderly market to allow supply and demand to establish a balance at a fair clearing price. This typically takes the form of counterparties stampeding to post aggressive late period bids or offers that leave other principals with little chance to submit a considered counter indication and which subsequently skews the price assessment process away from what might otherwise emerge as a fair-value clearing assessment.

Increasing reliance on electronic assessment methods by PRAs exacerbates the problem of time distortions on price assessments. Algorithmic trading engines can be programmed to submit last minute bids and offers to electronic platforms specifically to influence an assessment. As trading technology develops, the risk of distortion becomes more pronounced.

PRA assessments affect benchmarked physical trading, derivatives trading and assessment of tax liability and overarching tax regimes worth trillions of dollars. Flawed PRA assessment methodologies may give misleading directional signals and increase transactional costs and inefficiencies across markets which they influence. Improved accuracy and transparency of assessments improves the efficient allocation of economic resources.

### SUMMARY

According to one aspect of disclosed embodiments, a method of producing a price assessment of a market may include establishing an opening price (e.g., in accordance with a methodology outside of a price assessment module), setting the price assessment to the opening price, commencing an assessment period having a length, displaying the price assessment throughout the length of the assessment period, receiving pricing input indicative of financial activity relating to the market, updating the price assessment based on the pricing input, extending the length of the assessment period responsive to determining that a qualifying event has occurred, closing the assessment period upon expiration of the extended length of the assessment period, and finalizing the price assessment.

According to another aspect, a system for producing a price assessment value may comprise a price assessment module, an acceptable range module, a price assessment period module, an interface module, and a logging module. The price assessment module may be configured to update the price assessment value in response to receiving pricing input during a price assessment period, the price assessment period having a length. The acceptable range module may be configured to produce an acceptable value range based on the price assessment value. The price assessment period module may be configured to change the length of the price assessment period in response to detecting a qualifying event. The interface module may be configured to cause the price assessment value to be publicly accessible throughout the length of the price assessment period. The logging module may be configured to record a change history of the price assessment value, including the pricing input that caused the price assessment value to update.

According to yet another aspect, a method for producing a price assessment of a financial market during a period of time may comprise: publishing the price assessment to a publicly accessible location throughout the period of time, receiving pricing input, the pricing input comprising indicia of financial activity within the financial market between a first entity and a second entity, adjusting the price assessment based on the received pricing input, determining whether a qualifying event occurred within a critical portion of the period of time, increasing the period of time responsive to determining that the qualifying event occurred, and publishing a log of price assessment activity.

### BRIEF DESCRIPTION OF THE DRAWINGS

FIG. 1 illustrates a block diagram of a price assessment platform of a market according to certain implementations.

FIG. 2 illustrates a price assessment screen according to certain implementations.

FIG. 3 illustrates a flow diagram of a price assessment method according to certain implementations.

FIG. 4 illustrates a flow diagram of a method for determining whether the assessment period should close or be extended according to certain implementations.

### DETAILED DESCRIPTION

Disclosed embodiments generally relate to methods and systems for a price assessment platform. According to certain implementations, the price assessment platform may be configured to display and dynamically update a price assessment during an assessment period. The price assessment may be updated to reflect financial activity within a particular market. Representations of the financial activity may be received by the platform, processed, and used to algorithmically update the price assessment as needed. Where a qualifying event occurs within a critical period of the assessment period, the length of the assessment period may be increased.

Given concerns over the lack of transparency and inadequate audit trails delivered by existing assessment methodologies, certain embodiments may be configured to provide a complete and wholly queryable assessment history for each price point generated. Certain implementations of the platform may eliminate flaws inherent in existing methodologies as well as providing regulators with the fullest record and oversight of price formation used in benchmarks. Market order can be assured through the algorithmically controlled applicable price ranges and assessment movements which govern each assessment session.

Certain implementations may be configured to meet or otherwise address recommendations set out by the International Organization of Securities Commissions (“IOSCO”), national regulators, or other regulatory organizations to achieve the fullest definition of best practice in price discovery. For example, the platform may be configured to be IOSCO-compliant by, for example, giving priority to concluded transactions in making assessments. Implementations may contemporaneously document and retain relevant information and judgments made in reaching a price assessment (for example, to facilitate inquiries by market authorities), commit to make available to authorities audit trails and other related documentation, and require standards for who can submit data. These implementations may be used to eliminate flaws inherent in existing methodologies and provide regulators with a full record and oversight of price formation used in benchmarks.

While the platform may be used in the context of a commodity market, the platform may also be applied to other kinds of markets, such as foreign exchange, interest rates, equity, and credit markets.

### Price Assessment Platform

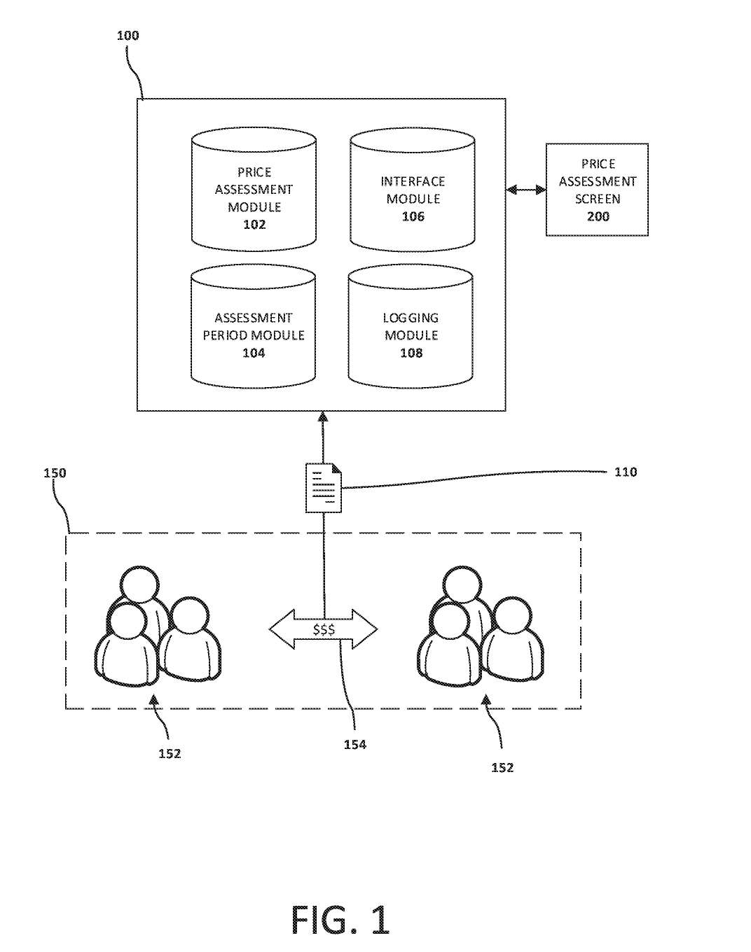

FIG. 1 illustrates a block diagram of a price assessment platform 100 according to certain implementations. The price assessment platform 100 may be a system, method, or other means for generating a price assessment. The price assessment platform 100 may comprise a price assessment module 102, an assessment period module 104, an interface module 106, and a logging module 108.

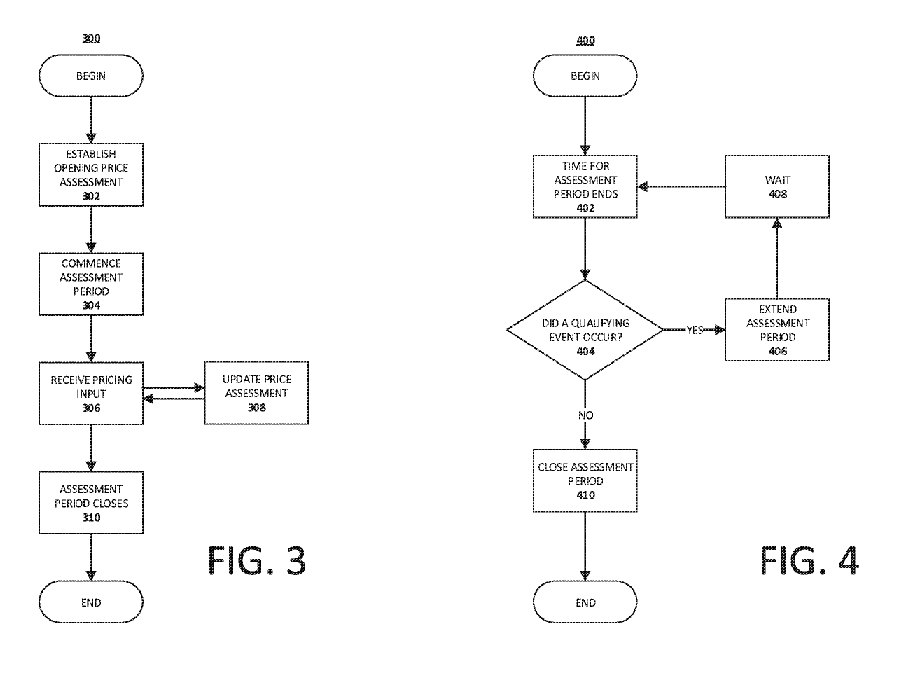

The price assessment module 102 may be a component of the price assessment platform 100 that generates a price assessment. For example, in certain implementations, the price assessment module 102 may comprise instructions that, when executed, generate an assessment based on price input 110 (for example, as shown and described below in FIG. 3).

The assessment period module 104 may be a component of the price assessment platform 100 that manages or otherwise determines the behavior of a period of time in which a particular price will be assessed (for example, as shown and described below in FIG. 4).

The interface module 106 may be a component of the price assessment platform 100 that controls interaction between users and the price assessment platform 100. For example, the interface module 106 may receive input from users, other systems, and other sources. The users may be market participants, staff members working with the platform 100, members of the public, and/or other users.

Additionally, the interface module 106 may provide output to users. For example, in certain implementations, the interface module 106 may be a module that hosts or manages a browser-accessible site that contains information. In certain implementations, the interface module 106 may interact with or otherwise cause a third-party site to update or change information. For example, the interface module 106 may be used to control a price assessment screen 200, such as in response to receiving a request from a user to display particular information. In certain implementations, the interface module 106 may expose application programming interfaces or other capabilities to external programs to enable the retrieval or query of information or capabilities.

In certain circumstances, the interface module 106 may facilitate interaction with users (such as market participants) by being configured to allow users to create and utilize accounts registered with the platform 100. The accounts may comprise username, login, and/or other authentication credentials and may be stored within, for example, a database associated with the interface module 106. This information may be utilized to enhance the interaction between the platform 100 and users. For example, the accounts may enable users to buy or sell products using the platform, submit pricing input, receive customized information, and perform other activities.

The logging module 108 may be a component of the price assessment platform 100 that is configured to log, store, or otherwise archive particular information. For example, the logging module 108 may be configured to keep a record of all price input 110 received, all price input 110 received that affects the price assessment, information used to produce the price assessment, a historical record of the price assessment, and other information.

For example, in certain implementations, some or all of each price assessment session may be electronically recorded. Further, some implementations of the logging module 108 may allow users to replay some or all of the session from start to finish in real time or at a variable speed. This feature may eliminate the challenge presented by existing PRA assessment methodologies of collating and re-engineering past session histories for compliance purposes, for example, from telephone, instant messaging, and email records. This may enable compliance overview of the overarching market context and narrative of each individual session and alleviate the risk that scattered inputs are overlooked, lost, or ignored.

In certain implementations, the logging module 108 may track, store, or otherwise maintain assessments made by the price assessment platform 100. For example, the logging module 108 may make this information available for retrospective historical analysis through a search facility by counterparty name and time stamp. The search facility may be configured to deliver quick and efficient breakdowns of the day's bids, offer, and trades from high to low or vice-versa by session and/or by defined periods of days, weeks, or months.

In certain implementations, the logging module 108 may provide a fully recorded, queryable session history for each published price. For example, the session history may recreate the sequence of any session or series of sessions without omitting input. This approach may be specifically designed to meet the full requirements of compliance authorities regarding the oversight of benchmark formation, for example as outlined in the IOSCO principles for PRAs.

The price input 110 may be any market information that may be useful in making a price assessment. In certain implementations, the price input 110 may comprise indicia of financial activity 154 between participants 152 in a particular market 150. For example, the price input 110 may comprise details of trades, bids, and offers made between the participants 152. The participants 152 may be entities that participate within the market 150, such as individuals, corporations, banks, financial institutions, and/or other participants.

The financial activity 154 may be any activity by or between participants 152 relating to the market 150. For example, the financial activity 154 may include transactions, deals, offers, counteroffers, sales, trades, or other activity. The financial activity 154 may also include events that occur outside of the market 150 that may nonetheless affect the market. For example, the financial activity 154 may be the behavior of other financial markets, activities in other markets, and other information.

In certain implementations, the price assessment platform 100 may be a computer system configured to receive input, perform processing, and transmit output. For example, the price assessment platform 100 may comprise a processor communicatively coupled to a computer readable media. The computer readable media may include any transitory or non-transitory media, such as hard disk drives, solid-state storage, NAND flash media, NOR flash media, tiered storage, network attached storage, optical storage, other storage means, and/or combinations thereof. The computer readable media may further comprise instructions capable of execution on the processor to achieve a particular result. For example, the systems and methods described herein may be stored as processor-executable instructions on the computer readable media.

### Price Assessment Screen

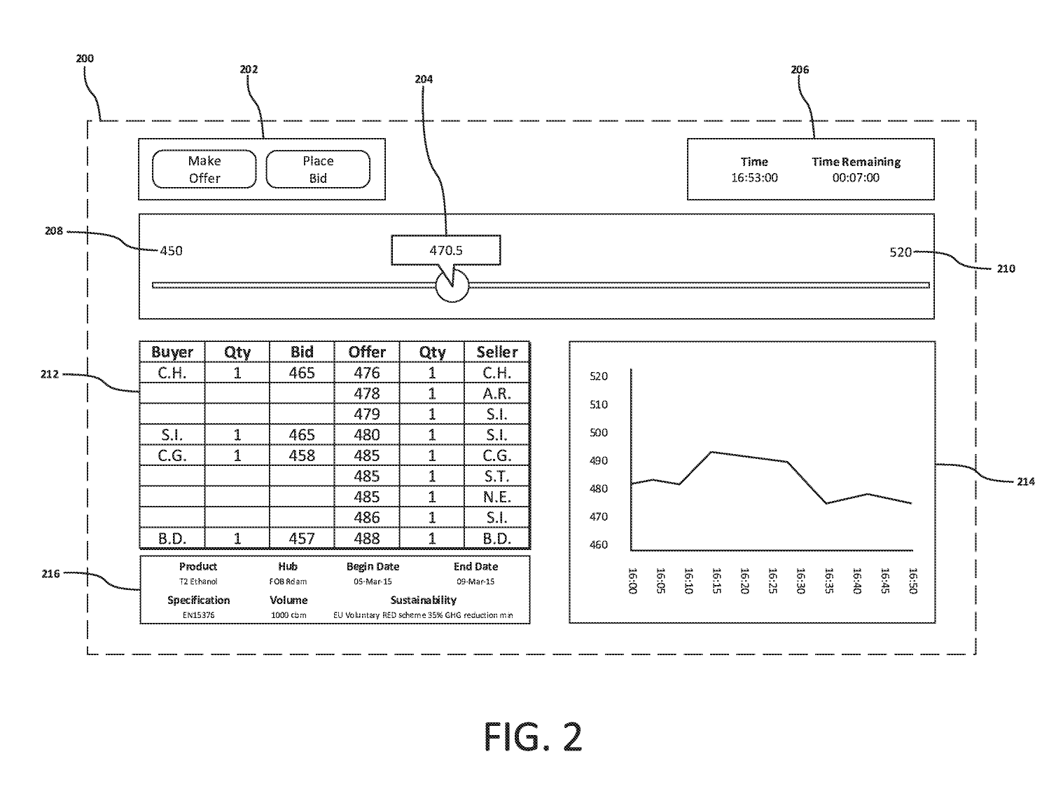

FIG. 2 illustrates an example price assessment window or screen 200, including purchase controls 202, a currently assessed price 204, time information 206, a lowest acceptable value or bid 208, a highest acceptable value or bid 210, a live price chart 212, a historical price chart 214, and product information 216, according to certain implementations. The price assessment screen 200 may be reached via a web portal, mobile application, or other means of accessing data remotely. Access may be enabled by, for example, the interface module 106.

The purchase controls 202 may be means for participating in the assessed market. For example, the purchase controls 202 may include means for making an offer, placing a bid, and/or performing other financial transactions.

The currently assessed price 204 may be the current or most recent assessed price. Prior to or immediately following the commencement of the assessment period, the currently assessed price 204 may be an opening price. Following activity within the market (for example, following receipt of price input 110), the currently assessed price 204 may be updated to reflect market conditions.

In certain implementations, the currently assessed price 204 may be permanently displayed. For example, from the start of the assessment period when an opening assessment is displayed through the end of the session when the final price assessment is declared, the currently assessed price 204 may be publicly available and displayed, thus enabling price transparency.

The time information 206 may be information relating to the current time and/or the time remaining in the current price assessment period. In certain implementations, the time information 206 may include a countdown timer showing the amount of time remaining before the current assessment period ends. In certain implementations where the price assessment period is tied to non-time factors, the time information 206 may display that information as well. For example, if the close of the price assessment period is tied to a trading frequency, then the time information 206 may display the current trading frequency and the trading frequency at which the price assessment period will close.

The price assessment screen 200 may display the lowest acceptable value 208 and the highest acceptable value 210, which represent the boundaries of the range of acceptable values of activity (such as the minimum or maximum acceptable values for bids, offers, and/or other transactions). This range may be established or set based on or with the opening assessment. The range may update and change as the currently assessed price 204 changes.

The live price chart 212 may be a table or other listing of a history of transactions, offers, bids, or other financial activity within the assessed market. For example, in certain implementations, the live price chart 212 may be a list of live bids and offers. The live price chart 212 may display real price input 110 in the market 150 by participants 152, which may affect the price assessment.

The chart of historical price 214 may be a chart representative of a history of transactions, offers, bids, or other financial activity within the assessed market. For example, the chart of historical price 214 may illustrate how the currently assessed price 204 has moved since the beginning of the session. In certain circumstances, the chart of historical price 214 may be an alternative visual representation of historical data to the live price chart 212. For example, the live price chart 212 may be a table, while the chart of historical price may be represented as a line chart.

The product information 216 may be supplemental information regarding the product for which the price is being assessed. For example, where the product is a commodity within a commodity market, the product information 216 may include descriptions of the product name, hub, begin date, end date, specification, volume, sustainability, and other such descriptive information.

### Price Assessment

FIG. 3 illustrates a flow diagram of a price assessment method 300, for example as implemented using the platform 100, according to certain implementations. At step 302, an opening assessment is established. In some embodiments, the opening assessment is prepared by staff engaging with market participants such as brokers and traders to establish views on current pricing in each market. The assessments may be conducted by, for example, phone, instant message, email, and/or other communication methods. The information gathered by the staff may be compiled, prepared, or otherwise analyzed to establish an opening assessment for each market being considered. In some embodiments, the assessment is based on historical data or predicted data. In certain implementations, the opening assessment is based on predictions, prior assessments, algorithms, activity in other markets, and other values. In certain implementations, the opening assessment may be based on the final assessment price from a previous session. In other implementations, the opening assessment may be based on a price received outside of the platform methodology in the price assessment platform 100. For example, the price may be received from a source other than a previous session.

In certain implementations, a dedicated website for each product to be assessed may be provided so participants can gauge the procedure. The website may be publicly available and not password protected, such that any interested party can follow the proceedings. In other implementations, access to some or all information could be restricted or limited.

At step 304, an assessment period may begin. In certain embodiments, for each market to be assessed, a time may be advertised, which every business day will be the basis for assessment to commence. At the appointed time the assessment period begins. For example, in certain implementations, the assessment period module 104 may determine an appropriate start time or that an appointed start time has been reached. For instance, the period may begin when a certain volume or frequency of trades, bids, offers, or other financial activity 154 has been reached. When the period begins, the current or opening assessment may be displayed at the price assessment screen 200 via the interface module 106.

The period may begin with the display of a screen that shows the opening assessment for the particular commodity (for example, the price assessment screen 200 showing the currently assessed price 204). This may be considered a starting price for the assessment period and may enhance transparency.

In certain implementations, the opening assessment may be based on price input 110 received by the platform 100. The price input 110 may be entered directly into the platform 100 or automatically received or gathered from other sources. The price input 110 may be a price assessment itself. The price input 110 may include factors that affect the price assessment. The price input 110 may be processed by the pricing assessment module 102 to produce the opening assessment. The price input 110, the factors, the price assessment, and other information may be made publicly available at, for example, the price assessment screen 200 via the interface module 106.

During the assessment period, price input 110 may be solicited from market participants 152. For example, during the assessment period, participants may be invited to directly or via an intermediary broker enter their interest to buy or sell the product on the exact terms quoted. These are invitations to treat and announce the participant's intention to be bound to the displayed price level according to the exact contractual terms outlined for the assessment. The participants may be registered participants.

At step 306, pricing input is received (such as price input 110) from various sources. In some implementations, the price input 110 may be information received directly from the participants 152. The price input 110 may be information received by monitoring or otherwise observing the financial activity 154. For example, in certain implementations, pricing information may include observed transactions, observed trades, observed bids, observed offers, and other pricing input. Price input 110 may be limited to price input 110 that meets quality standards. For example, pricing input that does not meet quality standards may be disregarded, or given less weight. Prices outside the range shown may be ignored and/or regarded as erroneous. Prices below a minimum quantity may be disregarded.

In certain implementations, price input 110 may be required to be delivered within a strict range linked to the current price through algorithms defined by the starting price and the recent market volatility of the price being assessed. This range may vary as the assessed price changes. The range may be configured to ensure order in the market and protect participants from manifest error in price entry. Speed breakers may also be used to manage price inputs to ensure that the market remains orderly. If a matched price cannot trade due to credit or other counterparty limitations, both prices may remain live on the screen and may affect the price assessment.

In certain implementations, the platform 100 may require that bids, offers, or trades conform to a standard that specifies particular acceptable quantity, period, and/or specification. Bids, offers, or trades that fail to meet the standard will not be considered towards the assessment.

At step 308, the price assessment is updated based on the received pricing input. Pricing input may be based on or depend from various information. The assessed price may be a function of real-time price moves, input prices, and observed trades. For example, in certain implementations, when participants 152 enter bids above or offers below the opening assessment, an algorithm will alter the price assessment automatically and immediately update the electronically displayed price assessment for the market.

As another example, in certain implementations, where one participant enters a bid price and another participant enters an offer price at the same level, the details will register in the price assessment platform 100 and close a deal between the two participants. It will register on the screen and this in turn will move the price assessment in accordance with output from the price assessment algorithm.

As another example, in certain implementations, where one participant enters a bid price and another participant enters an offer price at the same level, the details will register at a brokerage firm assisting with the order flow. If the brokerage firm can close a deal between the two participants it will register on the screen and this in turn will move the price assessment in accordance with output from the price assessment algorithm.

The platform 100 need not be operated by a brokerage firm or a debt capital market. However, the platform 100 may engage with brokerage firms to manage interests from participants that want to participate. The engagement with brokerage firms may be limited to brokerage firms that meet particular business practice standards.

A price input 110 (such as a bid) above the opening price assessment may increase the currently assessed price 204. A price input 110 (such as an offer) below the opening price may decrease the currently assessed price 204. At any point during the session a price input 110 (such as a bid) above the currently assessed price 204 may move the currently assessed price 204 up to at least the level of the price input 110. At any point during the session a price input 110 below the currently assessed price 204 may move the currently assessed price 204 down to at least the level of the price input 110. If there is a transaction at a currently assessed price 204, the currently assessed price 204 may become sticky, such that the algorithm may not allow the currently assessed price 204 to move on some price input 110 that does not generate a transaction. Without a trade the currently assessed price 204 might drift away from the price input 110 that previously altered the currently assessed price 204 depending on other price input 110 that the system 100 has received.

In certain implementations, where participants enter bids above or offers below the initial assessed price, an algorithm will accept the inputs that are within an acceptable range of the starting price and move the electronically displayed assessment accordingly for the market to see. The algorithm may calculate a fair value between bids and offers falling within the algorithmically acceptable range. In addition to or instead of the inputs, the fair value may be used as a price input. All prices entered may be made visible for market participants and any interested party.

At step 310, the assessment period closes. The close of the assessment period may be reached through various means. For example, the assessment period may close after a particular amount of time. For instance, the assessment period may close after ten minutes have passed since the assessment period commenced. As another example, the assessment period may close after the occurrence of a particular event. For instance, the assessment period may close after ten trades have been made, after the trading frequency passes a threshold, or after another occurrence. In some embodiments, the assessment period may close if it is determined that the assessment period should not be extended. This is shown, for example, in FIG. 4.

Extension of Time

FIG. 4 illustrates a flow diagram of a method 400 for determining whether the assessment period should close or be extended, according to certain implementations. The method 400 begins at step 402, when the predetermined period for the assessment ends. In certain embodiments, this step 402 may be reached, for example, when the period of time allotted for assessment has ended. For example, if the assessment period is ten minutes and ten minutes have passed, then the time for assessment period ends. This step need not or need not only be reached upon expiration of a timer. For example, an entity controlling the operation of the assessment platform may determine that the assessment period should end. This may be in response to various events or policies. As another example, the time for the assessment period may end based on other factors. For instance, the assessment period may end when the frequency of activity or rate of change of the assessed price drops below a threshold. Other criteria may also be used. Next, the flow moves to step 404.

At step 404, a determination is made as to whether a qualifying event has occurred. If a qualifying event occurs, then the flow moves to step 406. If not, then the flow moves to step 410. In certain implementations a qualifying event may be a transaction within a critical period of time. For example, the critical period may be a period of thirty seconds before the end of the assessment period. If there is activity during these thirty seconds, then a qualifying event has occurred. As another example, a qualifying event may be a change in the assessed price during the critical period of time. For instance, activity during the critical period of time is not a qualifying event unless it results in a change in the assessed price. Qualifying events may include but need not be limited to: a transaction, change in the currently assessed price 204 or a change in the range of inputs accepted.

The determination of which events are qualifying events may depend on various factors. For instance, the platform 100 may be configured to favor certainty in price over a quick determination and may set a low bar for which events qualify. In another instance, the platform 100 may be configured to favor speed in determining price and may have a high bar for qualifying events.

In certain embodiments, the definition of a qualifying event may change over time. For instance, the qualifying event may begin as any financial activity, such as a transaction, within the critical period, then for any subsequent extension, the qualifying event must be a transaction or price input 110 that results in a change in the assessed price, then be any change in the assessed price of more than $0.10, and so on. The change over time may be based on various factors, for instance, the number of extensions that have already been made, the current time, the total length of assessment, the total length of extensions, and other factors.

At step 406, the assessment period is extended. This step 406 is reached when it is determined in step 404 that a qualifying event occurred. The extension length may be fixed or variable. For example, in certain implementations, the extension time is constant. In other implementations, the extension length may change over time. For instance, the extension length may begin at a relatively high number and reduce to no extension at all as the number of extensions increases or as a result of other factors. The flow then moves to step 408, where the method waits until the time for assessment period ends again. Extensions also may be based on the number or type of certain events, such as timing of bids and/or offers or the extent to which a bid or offer differs from prior bids or offers.

At step 410, the assessment period closes. Once this step 410 has been reached, the assessed price is the final price.

As an example of the method 400, a platform may have an assessment period of ten minutes and qualifying events are purchases that change the assessment price within thirty seconds of the end of the assessment period. Once the assessment period ends, a check is made to determine whether any qualifying events occurred in the last thirty seconds. A check of the purchase history reveals that thirteen seconds before the assessment period ends, a purchase was made that changed the assessment price from two dollars to three dollars. As a result, the assessment period is extended for one minute. The process then waits for the adjusted assessment period to end again and another check of the purchase history is made. This time, while there was a transaction within the last thirty seconds, the transaction did not result in a change in the assessed price. As such, there was no qualifying event and the assessment period closes. Once the assessment period has ended, the price assessment on the screen at the time of conclusion will be the final price for the day.

As another example, the method 400 may be performed with a minimum assessment period of ten minutes and a critical period of thirty seconds. A qualifying event may be a change in the assessed price and the response to the qualifying event within the critical period is an extension of time of thirty seconds. This process continues for up to an additional three hours if the assessed price continues to change. After a total of three hours and ten minutes, the length of time of the critical period changes. A price received in the final twenty seconds will extend the assessment period by thirty seconds. This method will continue for a further fifty minutes until there has been a continuous twenty second period of price constancy. At the end of four hours the assessment period may be further extended by the assessor's staff if they determine that market conditions warrant an extension. If not the algorithm will calculate the final assessed price as being the price finally displayed. This prevents artificial movement and/or manipulation of the assessment by the submission of a substantial volume of bids or offers too close to the close of market for the bids or offers to be accepted.

In certain implementations, the method 400 need not wait until the assessment period ends to check if a qualifying event occurred. Instead, there may be a determination as to whether the critical time period is occurring and immediately extend time when a critical event is detected. For example, if the critical period is thirty seconds before the scheduled end of the assessment period and a qualifying event occurs twenty five seconds before the scheduled end, the time may be immediately extended upon determining that the qualifying event occurred rather than waiting for the end of the assessment period.

By allowing the assessment period to extend in the event of a price change within the critical period, the platform removes one flaw in the traditional PRA price assessment model, which typically sets a target end time and which demonstrably creates a disorderly trading stampede.

By allowing the assessment time period to extend in the event of continuing active interest, an important incentive for price manipulation is removed and the public can be assured of an orderly market and assessment. An extending price assessment time period may have logistical disadvantages for market participants, including dealing with staffing issues to accommodate an extendable assessment process. However, it is in these disadvantages that the demand from the public and regulators for order and transparency is achieved. A price assessment in an illiquid market may act as a benchmark or fundamental price driver for trade in a more liquid derivative or related market. Eradicating a fixed time assessment eliminates last minute inputs from being introduced to an assessment process solely to influence the price direction and unfairly improve the value of related trading positions in associated or derivative markets.

### Assessed Price and Range Algorithms

As described above, there may be an algorithm that programmatically and dynamically sets the acceptable price range for bids and offers. A price range algorithm may assess the range of acceptable price inputs 110. The price range algorithm may take into account recent session volatility. For example, if the price has been moving 1% daily, the price range algorithm may take into account this trend and set a range of +/−1% of the currently assessed price 204. If volatility is rising, the algorithm may dampen it by setting the range as an average of recent sessions. Once a price input 110 is received that is very near the lowest acceptable value 208 or highest acceptable value 210 the range may be extended slowly. A range extension may be considered a qualifying event that may trigger an extension of time. Prices may continue on their path, but only in steps that are a function of the session's volatility throughout.

### Additional Methodologies

One means for assessing price is a market on close methodology (MOC). The MOC methodology operates on the principle that “price is a function of time.” The MOC methodology may require approved principals and intermediaries to discuss bids, offers, and trades for a standardized product specification in a short period (30-45 minutes), which closes at a fixed point in time near the end of the trading day, after which no fresh trade information is accepted. All bids and offers must be submitted by named counterparties and must represent a firm willingness to trade at the stated level. Then, inputs gathered during the period in conjunction with the information gathered is used to create and publish a time-specific price assessment.

An eWindow version of this methodology allows principals to directly enter bids and offers for inclusion in MOC assessment with a direct execution facility. Bids, offers and trades are otherwise communicated either directly or through intermediary brokers to assessors for inclusion in MOC assessment.

The MOC methodology may incentivize distortive trading behavior. For example, counterparties may post aggressive late period bids or offers that leave other principals with little chance to submit a considered counter indication, which subsequently skews the price assessment process away from what might otherwise emerge as a fair value clearing assessment. The methodology arguably gives undue and artificial influence to the effect of time when it serves as the main fundamental driver of price, ignoring the key requirement of any efficient, orderly market to allow supply and demand to establish a balance at a fair clearing price.

Assessment methodologies may include time-stamped bid/ask ranges, averages of deals done in a period, volume weighted averages of deals done over the entire day as well as cumulative transaction averages across a month and cumulative daily averages.

In more liquid markets counterparties may be asked to submit bids, offers and trades either directly or through intermediary brokers to a published electronic bulletin board which calculates an average price for the commodity weighted by volume. Pricing periods may be longer than those employed by MOC methodologies but still operate between set hours.

Other methodologies may require the assessor to weigh independently canvassed information on bids, offers and trades from principals and intermediaries before establishing a single price fix which the assessor believes to be in line with the published methodology. These methodologies in a more liquid market may consist of an arithmetic average of submissions with the highest and lowest outliers trimmed from the top and bottom of the day's range.

Certain methodologies do not require submissions to be delivered by named counterparties in order to be considered towards its assessments. These methodologies also may not employ vetting procedures for counterparties wishing to deliver information towards an assessment process.

These methodologies run the risk that an externally imposed cut-off time can encourage distortive late-session trading behavior geared towards the peculiarities of the assessment methodology rather than the bona fide supply/demand dynamics of the actual market. As with MOC methodologies this can establish time as an artificially restricted and distortive price determinant, rather than allowing supply and demand fundamentals to find a natural balance in an orderly market not subject to an artificial restriction.

These methodologies may also give undue subjective assessment leeway to individual assessors grappling with scattered, incomplete and often partial arrays of information, not necessarily delivered by named or vetted counterparties.

The above specification provides a complete description of exemplary embodiments of the invention, as claimed below. Although various embodiments of the invention as claimed have been described above with a certain degree of particularity, or with reference to one or more individual embodiments, those skilled in the art could make alterations to the disclosed embodiments without departing from the spirit or scope of this disclosure. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the disclosure as defined in the following claims.

What is claimed is:

1. A method of producing a price assessment of a market, the method comprising:
establishing an opening price;
setting the price assessment to the opening price;
commencing an assessment period having a length;
displaying the price assessment throughout the length of the assessment period;
receiving pricing input indicative of financial activity relating to the market;
updating the price assessment based on the pricing input;
extending the length of the assessment period responsive to determining that a qualifying event has occurred;
closing the assessment period upon expiration of the extended length of the assessment period; and
finalizing the price assessment.

2. The method of claim 1, wherein the length of the assessment period is extended more than once.

3. The method of claim 2, wherein the qualifying event of a first extension is different from the qualifying event of a second extension.

4. The method of claim 1, wherein receiving pricing input further comprises logging the received pricing input and displaying a representation of the logged pricing input.

5. The method of claim 4, wherein the pricing input is logged such that it may be played back.

6. The method of claim 1, wherein the opening price is based on a final assessment price of a previous session or a price received from a source other than a previous session.

7. The method of claim 1, wherein the price assessment is updated responsive to determining that the pricing input is a qualifying pricing input.

8. The method of claim 7, wherein the qualifying pricing input is within a range of acceptable values comprising a minimum acceptable value and a maximum acceptable value.

9. The method of claim 8, wherein the range of acceptable values is based on the price assessment.

10. The method of claim 9, wherein one or both of the minimum acceptable value and the maximum acceptable value changes responsive to the price assessment being updated.

11. The method of claim 1, wherein the qualifying event comprises the receipt of pricing input within a critical period of the length of the assessment period.

12. The method of claim 11, wherein the qualifying event further comprises the receipt of pricing input within the critical period of the length of the assessment period that causes the price assessment to be updated.

13. A system for producing a price assessment value, comprising:
a price assessment module configured to update the price assessment value in response to receiving pricing input during a price assessment period, the price assessment period having a length;
an acceptable range module configured to produce an acceptable value range based on the price assessment value;
a price assessment period module configured to change the length of the price assessment period in response to detecting a qualifying event;
an interface module configured to cause the price assessment value to be publicly accessible throughout the length of the price assessment period; and
a logging module configured to record a change history of the price assessment value, including the pricing input that caused the price assessment value to update.

14. The system of claim 13, wherein the interface module is further configured to cooperate with the logging module to enable a user to replay a portion of the change history.

15. The system of claim 13, wherein the qualifying event comprises a change to the price assessment value within a critical time period.

16. The system of claim 13, wherein the price assessment module is further configured to determine whether the pricing input meets a set of standards prior to updating the price assessment value.

17. A method for producing a price assessment of a financial market during a period of time, comprising:
publishing the price assessment to a publicly accessible location throughout the period of time;
receiving pricing input, the pricing input comprising indicia of financial activity within the financial market between a first entity and a second entity;
adjusting the price assessment based on the received pricing input;
determining whether a qualifying event occurred within a critical portion of the period of time;
increasing the period of time responsive to determining that the qualifying event occurred; and
publishing a log of price assessment activity.

18. The method of claim 17, wherein the price assessment activity comprises one or more of the pricing input, the indicia of financial activity within the financial market, the first entity, the second entity, the period of time, or the price assessment.

19. The method of claim 17, wherein the qualifying event is an adjustment of the price assessment.

20. The method of claim 17, wherein the log is published to the publicly accessible location.
